(19) United States
(12) Patent Application Publication
(10) Pub. No.: US 2006/0164923 A1
(43) Pub. Date: Jul. 27, 2006

(54) Novelty wall hanging

(76) Inventor: Linda Feister, New Caney, TX (US)

Correspondence Address: LITMAN LAW OFFICES, LTD, PO BOX 15035, CRYSTAL CITY STATION, ARLINGTON, VA, 22215, US

(21) Appl. No.: 11/041,410

(22) Filed: Jan. 25, 2005

(51) Int. Cl. G04B 37/00; A47G 1/16

(52) U.S. Cl. 368/276

(57) ABSTRACT

A novelty wall hanging depicting an image made from a plurality of artistically arranged sequins adhesively mounted on a layer of holographic material that is adhesively mounted on the surface of a finished wood article. The holographic material can be a holographic paper or film and can be secured to the surface of the finished wood article with and adhesive material. Sequins of one or multiple colors can be used depending on the image depicted and the taste of the consumer. An adhesive material is applied to the back of each sequin and then the sequin is mounted to the holographic material in accordance with the image being created. Glue varnish is applied over the entire sequin image to permanently secure the sequins and provide an attractive sheen. A clock is inserted preferably at the base of the wood article for added decoration and functionality.

### BACKGROUND OF THE INVENTION

1. Field of the Invention

The present invention relates generally to wall hangings, and more specifically to a novelty wall hanging made from a contoured piece of finished wood, and has a layer of holographic material adhesively mounted on the surface of the wood and a plurality of sequins artistically arranged and adhesively mounted on the holographic surface to simulate various graphic representations.

2. Description of the Related Art

Many homes, businesses and other structures are decorated with wall hangings of various types. Wall hangings containing a photograph or depicting an aesthetic scene or graphic representation are well known. Yet, wall hangings having a wood foundation decorated with a layer of holographic material and having colored sequins arranged as a graphic representation on top of the holographic layer are not known.

Various decorative wall hangings are known, and various inventions have been directed toward decorating wall hangings with various methods, but none disclose the decorative wall hanging of the present invention.

Thus, a novelty wall hanging solving the aforementioned problems is desired.

### SUMMARY OF THE INVENTION

The invention is a novelty wall hanging depicting an image made from a plurality of artistically arranged sequins that are adhesively mounted on a layer of holographic material that is adhesively mounted to the surface of a finished wood article. The wood article is a planar piece of wood that may be equipped with contoured edges, and is sanded, stained and painted on both sides. An adhesive material is applied to the back of the holographic material and the holographic material is subsequently mounted to the surface of the wood article such that it covers the entire front surface of the wood article. Sequins of one or multiple colors can be used depending on the image depicted and the taste of the consumer. An adhesive material is applied to the back of each sequin and the sequin is subsequently mounted to the surface of the holographic material in accordance with the image being created. Glue varnish is applied over the entire sequin image to permanently secure the sequins and provide an attractive sheen. A clock is inserted preferably at the base of the wood article for both added decoration and functionality.

Accordingly, it is a principal object of the invention to provide a novelty wall hanging for decorating a wall that uses a holographic background and artistically arranged sequins of one or multiple colors to create an image on the surface of a wood article.

It is another object of the invention to provide a novelty wall hanging having a clock inserted in the wood article for additional decoration and functionality.

It is a further object of the invention to provide a novelty wall hanging capable of depicting a plethora of images.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental perspective view of the novelty wall hanging according to the present invention.

FIG. 2 is a front perspective view of the novelty wall hanging according to the present invention depicting a deer.

FIG. 3 is a front perspective view of the novelty wall hanging according to the present invention depicting a knight on a steed.

FIG. 4 is a front perspective view of the novelty wall hanging according to the present invention depicting a peacock perched on a branch.

FIG. 5 is a rear perspective of the novelty wall hanging according to the present invention.

Similar reference characters denote corresponding features consistently throughout the attached drawings.

### DETAILED DESCRIPTION OF THE PREFERRED EMBODIMENTS

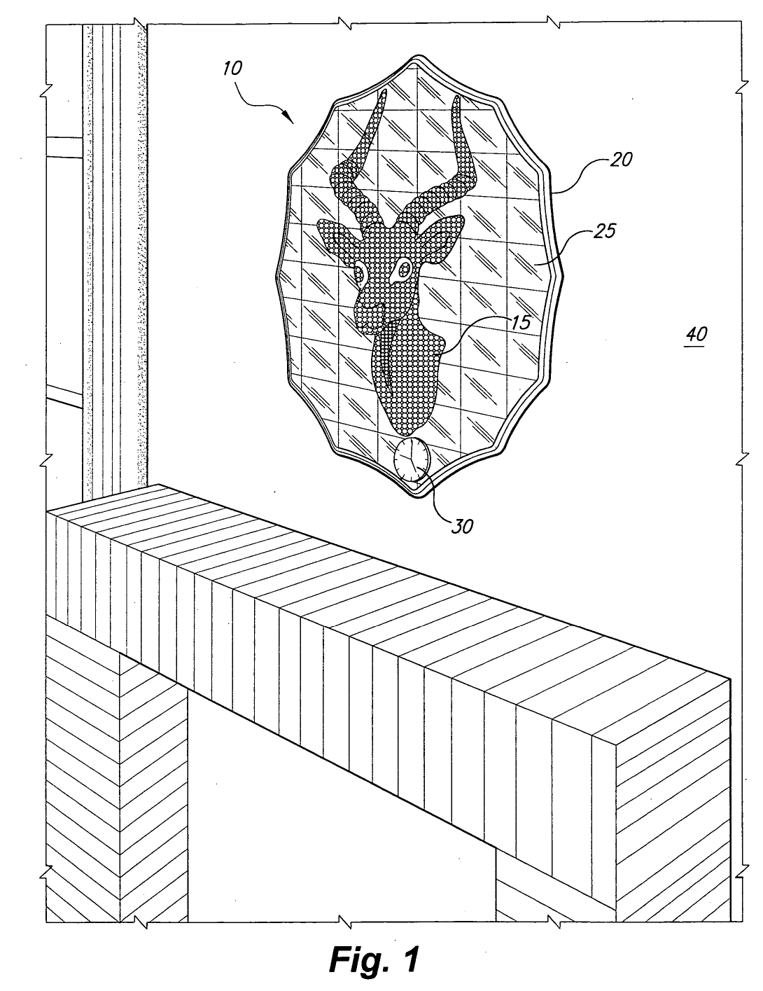

The present invention is a novelty wall hanging designated generally as 10. Referring to FIG. 1, the novelty wall hanging 10 is a decorative item depicting an image made from a plurality of artistically arranged sequins that are adhesively mounted on a layer of holographic material that is adhesively mounted on the surface of a finished wood article.

The novelty wall hanging 10 is a decorative wall hanging designed to enhance the aesthetic value of a wall 40. The wall 40 can be part of a room, hallway, foyer, etc. Alternatively, the wall hanging could be adapted as a table piece.

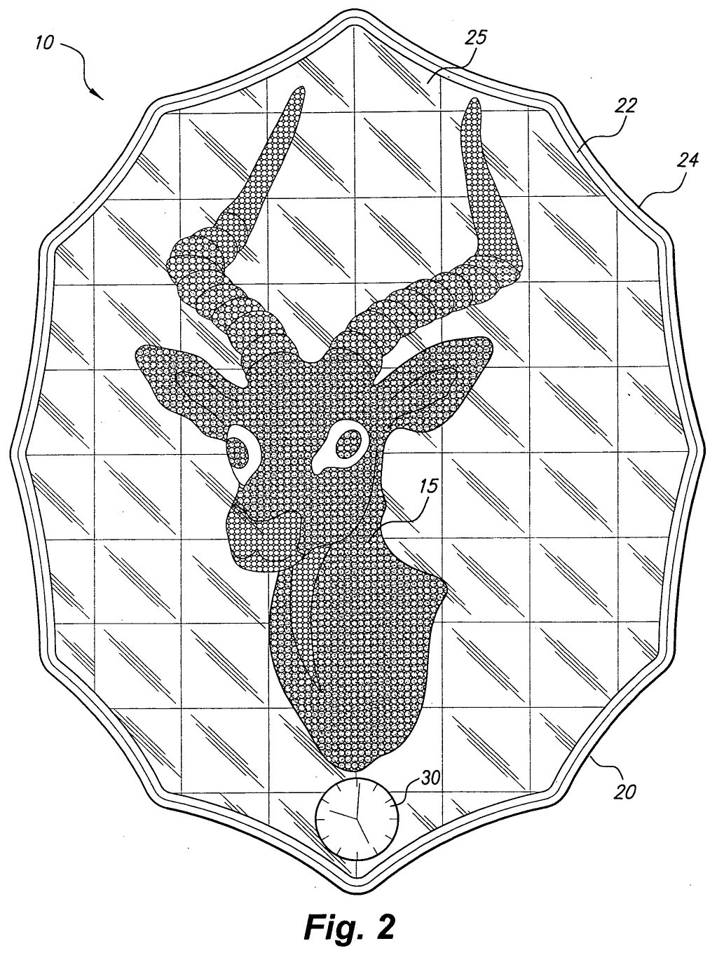

Referring to FIGS. 1 and 2, the novelty wall hanging 10 has a base comprising a wood article 20. The wood article 20 is a planar piece of wood, preferably with contoured, sculpted edges as indicated at 22 and 24. Both sides of the wood article 20 are sanded, stained, and painted to provide a finished appearance. As an alternative, the base can be made from a number of materials rigid enough to sustain a planar configuration (for example, plastic, metal, etc.). A clock 30 is provided, preferably at the base of the wood article 20 for added decoration and functionality.

Wood article 20 is provided with a layer of holographic material 25 that is adhesively mounted to the surface of one side of wood article 20. The holographic material 25 is preferably a holographic paper or holographic film but can be any material having a holographic pattern disposed on one side thereof. An adhesive material, such as glue, is applied to the back of the holographic material 25 and it is subsequently mounted to the surface of wood article 20.

The novelty wall hanging 10 is a decorative item depicting an image 15, made from a plurality of artistically arranged sequins that are adhesively mounted on the surface of the holographic material 25. Sequins of one or multiple colors can be used depending on the image 15 depicted and the taste of the consumer. The image 15 in this instance is the head of a deer. In order to create the image 15, an adhesive material, such as glue, is applied to the back of each sequin and the sequins are subsequently arranged and mounted to the surface of the holographic material 25 to create the image.

Glue varnish may be applied over the entire sequin image 15 to permanently secure the sequins and provide an attractive sheen.

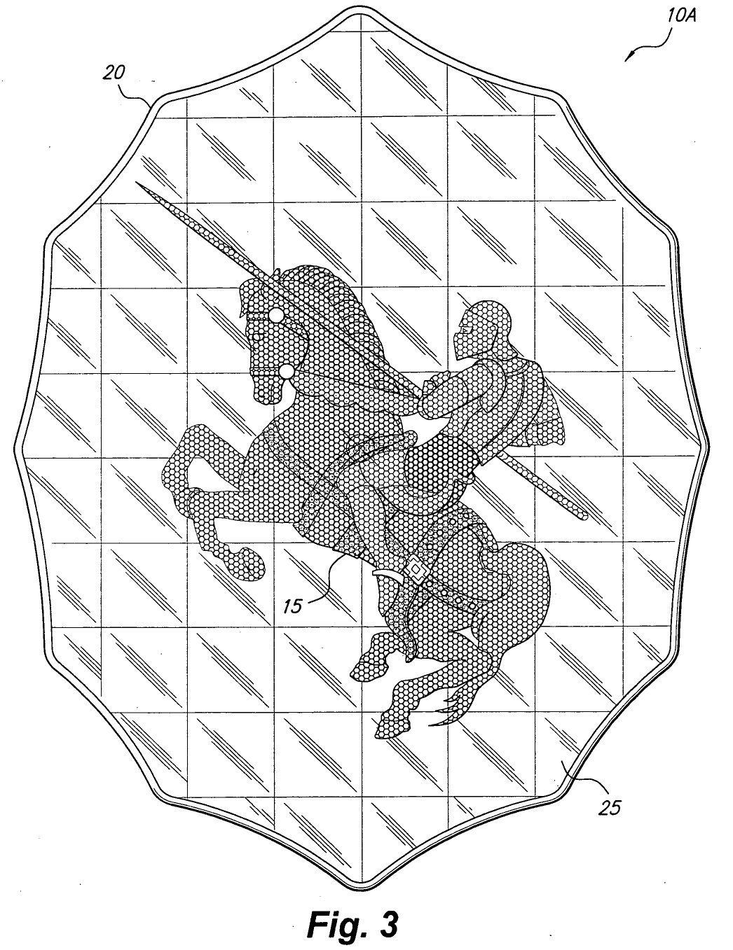

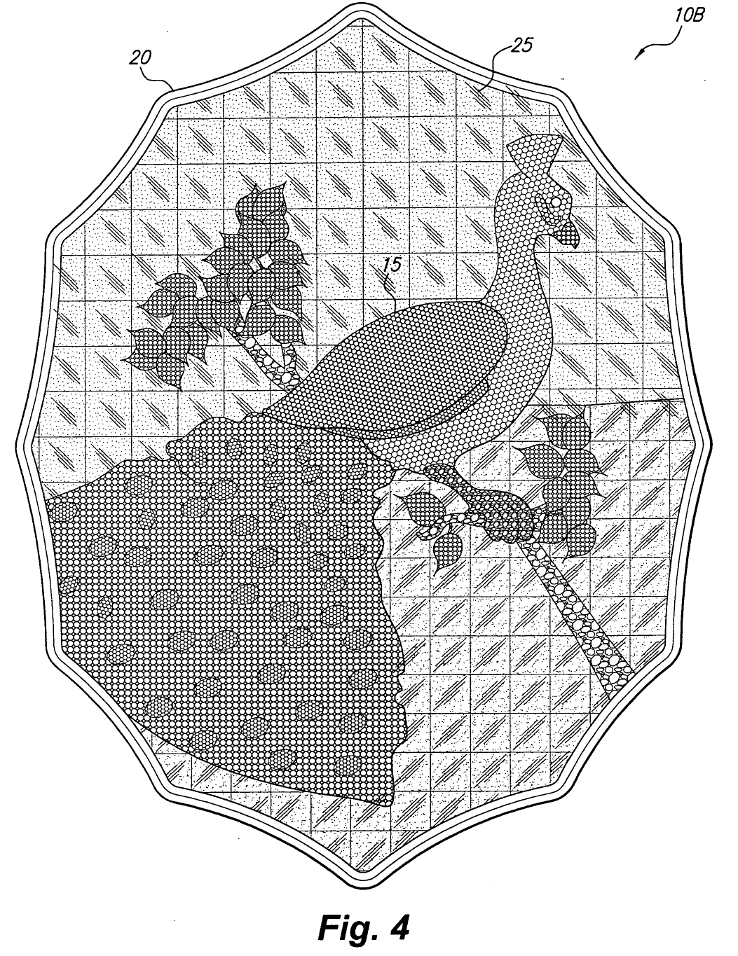

Referring now to FIGS. 3 and 4, alternative embodiments of the novelty wall hanging 10A and 10B are shown. Sequins are artistically arranged on the holographic material 25 that is adhesively mounted to the finished wood article 20 to create images 15 that simulate a knight mounted on a steed and holding a lance and a peacock perched on a branch. Clearly, then, the sequins can be arranged to create any one of a wide variety of images to be depicted on novelty wall hanging 10.

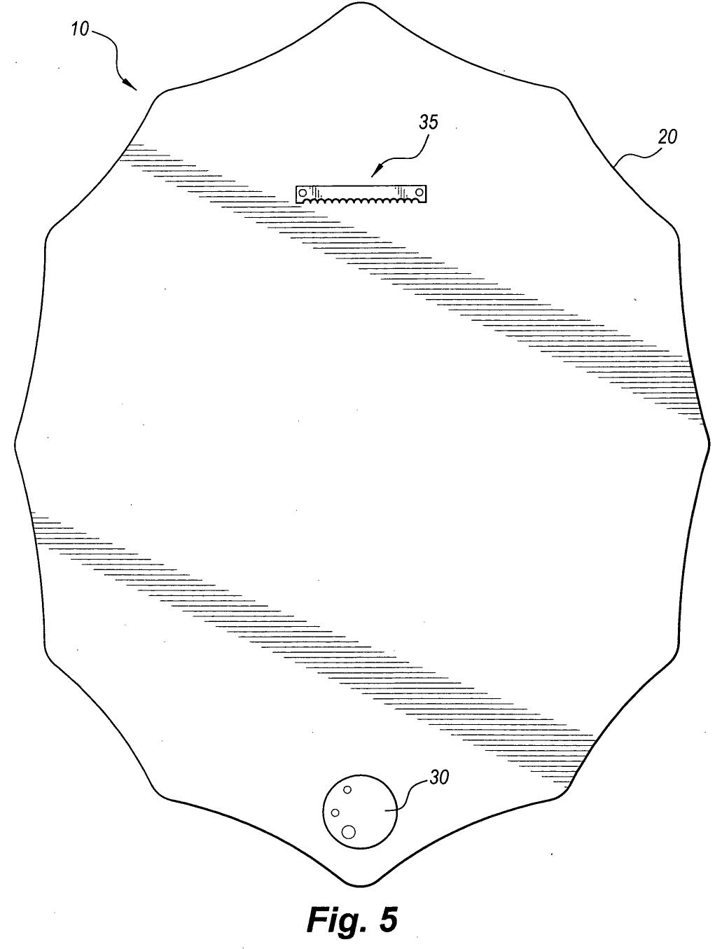

Referring to FIGS. 1 and 5, the novelty wall hanging 10 can be hung on the wall 40 using various anchoring arrangements. Referring to FIG. 5, a notched bracket 35 is screwed onto the rear surface of the wood article 20. The notched bracket 35 is put on a partially recessed nail or screw (not shown) in the wall 40 to mount or hang the novelty wall hanging 10 on wall 40. This is but one of a wide number of hanging hardware that may be used to mount the invention to hang on a wall.

It is to be understood that the present invention is not limited to the embodiments described above, but encompasses any and all embodiments within the scope of the following claims.

I claim:

1. A novelty wall hanging comprising:
a finished article having a planar configuration;
a layer of holographic material, adhesively mounted on the surface of said finished article;
a plurality of artistically arranged sequins, adhesively mounted on said layer of holographic material, and arranged to create an image depicting a predetermined object; and
means for mounting said wall hanging on a wall.

2. The novelty wall hanging as claimed in claim 1, wherein said finished article further has contoured edges.

3. The novelty wall hanging as claimed in claim 1, wherein said sequins are made of a variety of predetermined colors.

4. The novelty wall hanging as claimed in claim 1, further comprising:
a clock mounted in said wall hanging, for added decoration and function.

5. The novelty wall hanging as claimed in claim 1, wherein said finished article is made of wood.

6. The novelty wall hanging as claimed in claim 1, wherein said holographic material is holographic paper or holographic film.

7. A novelty decoration comprising:
a finished rigid article having a planar configuration;
a layer of holographic material, adhesively mounted on the surface of said finished article;
a plurality of artistically arranged sequins, adhesively mounted on said layer of holographic material, and arranged to create an image depicting a predetermined object.

8. The novelty decoration as claimed in claim 7, wherein said finished article further has contoured edges.

9. The novelty decoration as claimed in claim 7, wherein said sequins are made of a variety of predetermined colors.

10. The novelty decoration as claimed in claim 7, further comprising a clock mounted in said wall hanging, for added decoration and function.

11. The novelty decoration as claimed in claim 7, wherein said finished article is made of wood.

12. The novelty decoration as claimed in claim 7, wherein said holographic material is a holographic paper or holographic film.
